(19) United States
(12) Patent Application Publication
(10) Pub. No.: US 2016/0200481 A1
(43) Pub. Date: Jul. 14, 2016

(54) LABEL ASSEMBLY WITH RECYCLABLE LINER

(71) Applicant: Labelcraft Products Ltd., Pickering (CA)

(72) Inventor: Brian TOMLINSON, Pickering (CA)

(73) Assignee: Labelcraft Products Ltd., Pickering (CA)

(21) Appl. No.: 14/993,566

(22) Filed: Jan. 12, 2016

(30) Foreign Application Priority Data
Jan. 14, 2015 (CA) 2878591

(51) Int. Cl. B65D 25/20; G09F 3/10; C09J 7/02; G09F 3/02

(52) U.S. Cl. CPC B65D 25/205; G09F 3/02; G09F 3/10; C09J 7/0235; G09F 2003/0241; G09F 2003/0223; G09F 2003/026; G09F 2003/0272; C09J 2203/334; C09J 2400/28

(57) ABSTRACT

A label assembly is described which includes a top layer having a front side and a back side and a repositionable adhesive covering the entirety of the back side of the top layer. The label assembly also includes a silicone-free liner contacting the repositionable adhesive to sandwich the repositionable adhesive between the top layer and the liner.

The present application claims priority to Canadian Patent Application Number 2,878,591 filed Jan. 14, 2015, the contents of which are incorporated herein by reference.

### FIELD

The present application relates to a label assembly and, more particularly, to a pressure-sensitive label having a recyclable liner.

### BACKGROUND

Pressure sensitive labels are commonly applied to various products to identify information associated with the product. Such labels are used in numerous environments to provide a variety of functions including, for example, identifying the source or destination of goods, identifying a price associated with goods, identifying nutritional information associated with a food product, etc.

Typically, pressure sensitive labels include a top layer which is configured for being printed upon. The top layer is coated with adhesive on a bottom side. The label may not be used immediately following its manufacture and so a release liner is placed on the other side of the adhesive to prevent the adhesive from unintentionally sticking to other items. The release liner is coated with a silicone release agent to allow the release liner to be easily removed from the adhesive when the user is ready to put the label to use.

Typical municipal recycling facilities are not equipped to recycle release liners containing a silicone release agent. More particularly, the silicone release agent may need to be scraped off the release liner to permit recycling. Since this process is difficult, used release liners are typically sent to the landfill.

While this problem has been recognized for some time, previous solutions to this problem have been inadequate. More specifically, attempts to solve this issue have led to the development of liner-less labels. These labels do not have a release liner and typically have a silicone release agent applied to the printable side of the top layer to allow the labels to be released from the roll. The disadvantages to this approach are numerous. For example, since the labels do not have a base layer (i.e. a liner), die cut shapes are not possible.

### BRIEF DESCRIPTION OF THE DRAWINGS

Reference will now be made, by way of example, to the accompanying drawings which show example embodiments of the present application, and in which:

FIG. 1 shows a perspective view of a label assembly in accordance with example embodiments of the present disclosure;

FIG. 2 shows a side view of the label assembly of FIG. 1;

FIG. 3 shows a top view of a die cut label assembly in accordance with example embodiments of the present disclosure; and

FIG. 4 is a perspective view of a label assembly that includes a single label in accordance with example embodiments of the present disclosure.

Similar reference numerals may have been used in different figures to denote similar components.

### DETAILED DESCRIPTION

In accordance with the present application, there is provided a label assembly. The label assembly includes a top layer having a front side and a back side and a repositionable adhesive covering the entirety of the back side of the top layer. The label assembly also includes a silicone-free liner contacting the repositionable adhesive to sandwich the repositionable adhesive between the top layer and the liner.

In another aspect, there is provided a package having a label. The package includes a label having a top layer having a front side and a back side and a repositionable adhesive covering the entirety of the back side of the top layer. The package further includes a package body directly contacting the repositionable adhesive to sandwich the repositionable adhesive between the top layer and the package body.

In another aspect, there is provided a method of preparing a label assembly. The method includes: i) applying a repositionable adhesive to an entirety of a back side of a top layer of the label assembly; and ii) covering the repositionable adhesive with a silicone-free liner by applying the liner directly to the repositionable adhesive to sandwich the repositionable adhesive between the top layer and the liner.

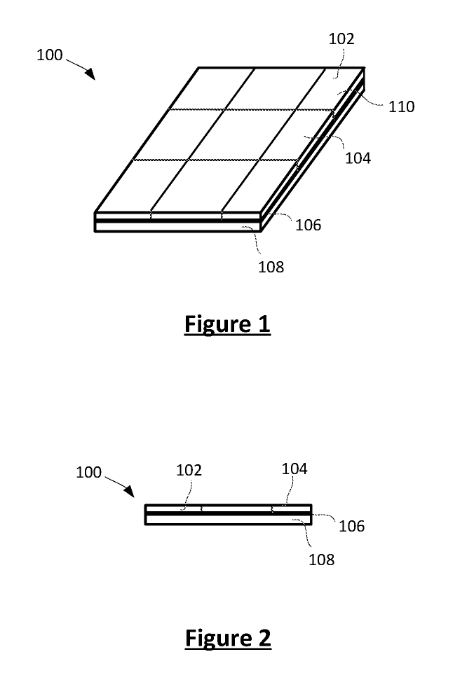

Reference is first made to FIG. 1 and FIG. 2. FIG. 1 shows a perspective view of a label assembly 100 and FIG. 2 shows a side view of the label assembly 100. The label assembly 100 includes a plurality of pressure sensitive labels 110. The label assembly 100 includes a top layer 102. In the example illustrated, the top layer 102 is a label sheet which includes a plurality of pressure-sensitive label regions, each associated with a separate label 110. More particularly, the example label sheet includes nine label regions, each associated with a separate label 110. The number of labels provided on the label sheet may, however, be different in other embodiments.

The top layer 102 has a front side 104 and a back side opposite the front side. The front side 104 may be configured for receiving a printed layer, such as ink. Accordingly, the front side of the top layer 102 may include indicia printed thereon. Such indicia may be, for example, a graphic or text, which may be printed using ink. For example, in some embodiments, a logo may be printed on the label. In some embodiments, pricing information, nutritional information (e.g., associated with a food product), shipping information (such as a recipient or sender's address), or other information may be printed on the front side 104 of the top layer 102. The back side, which is not shown in FIG. 1 or FIG. 2, is parallel to the front side.

The label assembly 100 may, in at least some embodiments, be distributed as a blank label. That is, in some embodiments, the top layer 102 may not have indicia printed thereon when the label is distributed; the top layer 102 may be printed on or written on after manufacture (e.g. by an end user).

The top layer 102 is paper-based and may have a paper density between fifty and one hundred and fifty grams per square meter (GSM). In an embodiment, the top layer 102 is constructed of 75 GSM paper. The top layer 102 may be a film or plastic-based paper in other embodiments. In an embodiment, the top layer 102 is uncoated paper. In another embodiment, the top layer 102 may have a machine-grade finish and/or may be a coated paper to allow for easy dispensing.

The label assembly 100 also includes a repositionable adhesive 106. The repositionable adhesive is a microsphere adhesive which allows for repositioning of the label due to the use of small particles. The repositionable adhesive is a low-tack pressure-sensitive adhesive. The adhesive may use particles (which may also be referred to as spheres) between 10 and 250 microns. In at least some embodiments, the adhesive may be of the type commonly used on Post-it™ notes. The adhesive may be of the type described in U.S. Pat. No. 3,691,140 which was filed Mar. 9, 1970 by Spencer Ferguson Silver and which is incorporated herein by reference.

The repositionable adhesive is applied to the back side of the top layer 102. More particularly, the repositionable adhesive 106 covers the entirety of the back side of the top layer 102. In at least some embodiments, the adhesive applied to the back side of the top layer 102. The application of the adhesive 106 may be performed, in at least some embodiments, using a roller. Each label 110 that is provided by the top layer 102 has a back side that is entirely coated by the adhesive such that all portions of the back side are sticky. That is, the back side of each label region of the top layer directly contacts the adhesive 106.

The label assembly also includes a silicone-free liner 108, which will generally be referred to as a liner 108 herein. The liner 108 directly contacts the adhesive 106 at a side of the adhesive that is opposite the side that contacts the top layer 102. The liner contacts the entirety of a side of the adhesive. Accordingly, the liner 108 effectively sandwiches the adhesive between the top layer and the liner; the adhesive acts as a middle layer and the liner 108 acts as a bottom layer. The adhesive 106 and the liner 108 are the only two layers that are below the top layer 102; the adhesive 106 is the only layer between the liner 108 and the top layer 102.

As noted above, the liner 108 is free of silicone. While typical liners 108 used in label assemblies include a release agent, such as silicone, the liner 108 of the embodiment of FIG. 1 and FIG. 2 includes no silicone and is recyclable using common recycling techniques found in modern day recycling facilities. Due to the use of the repositionable adhesive, the label may be released from the liner 108 without a release agent, such as silicone. A release agent is a chemical that is used to prevent other materials from bonding to surfaces. Traditionally, silicone is used as an adhesive release agent; however, the liner 108 is not treated with silicone and, in at least some embodiments, includes no adhesive release agent (i.e. is a “release-agent-free” liner).

The liner 108 is uncoated, in at least some embodiments. In other embodiments, the liner is coated and/or has a machine grade finish.

The liner 108 has an external side (i.e., bottom side) opposite the side of the liner that contacts the adhesive. The external side is also uncoated in an embodiment and does not contact any adhesive. In some embodiments, the label assembly may be provided on a roll, in which case the external side of the liner contacts the top layer of another portion of the roll.

The liner 108 is paper-based in an embodiment. That is, the liner 108 is constructed of paper, allowing for easy recycling of the liner 108. The liner 108 is not treated with silicone. In some embodiments, the liner 108 is untreated paper. In other embodiments, the liner 108 is treated, but is treated without silicone. The liner has a paper density sufficient to allow the liner 108 to be removed without tearing. In at least some embodiments, the liner is constructed of a paper having a paper density greater between 50 and 150 grams per square meter. In one embodiment, uncoated 75 GSM paper is used.

The liner 108 is unbleached kraft paper in some embodiments. Kraft paper is produced from chemical pulp produced in the kraft process. In other embodiments, the liner 108 may be copy paper. Machine grade paper, film or plastic may also be used in some embodiments.

The liner 108 is a single-layer liner. That is, the liner 108 has homogeneous construction such that it is uniform in material throughout.

In the embodiment of FIGS. 1 and 2, the top layer 102 is butt cut to produce a plurality of butt-cut labels 110. Butt cut labels have no gap between them and have square-corners. In at least some embodiments, the label assembly 100 may be perforated to allow the labels to be separated. More particularly, the liner 108 may be perforated at regions which demarcate the labels. That is, the perforations may separate one label 110 from another.

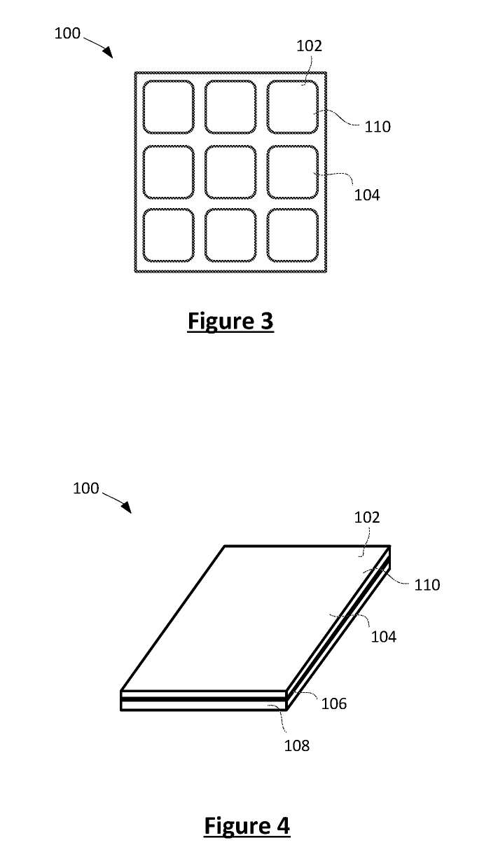

Referring now to FIG. 3, a top view of an alternate label assembly is illustrated. The label assembly of FIG. 3 has similar construction to that in FIGS. 1 and 2, except that the top layer 102 is die cut instead of being butt cut. Die cut labels 110 may have rounded corners and also have spacing between each label 110. That is, there is a gap separating one label 110 from another. Like the butt cut label assembly, the die cut label assembly may also include perforations separating one label 110 from another. The perforations may be provided midway between the labels (i.e., between midway between ends of each gap separating the labels).

As illustrated in FIGS. 1 to 3, the label assembly 100 may be provided in the form of a flat sheet. The flat sheet may, for example, be configured for insertion within a sheet-feed printer. For example, the flat sheet may be 8.5″×11″, or another standard paper size. In such embodiments, the label assembly 100 may include a plurality of labels. In other embodiments, the label assembly 100 may be provided in the form of a roll. For example, the roll of labels may be configured for insertion within a printer that is adapted to receive a roll. For example, the labels may be scale labels that are used in a scale printer, such as a deli scale printer. A scale printer is a printer that is connected to a scale to allow for customized printing based on the weight measured at the scale.

Referring now to FIG. 4, in some embodiments, the label assembly may include only a single label. More particularly, a label assembly having a top layer 102 that includes a single label 110 may be provided. The top layer 102 contacts the adhesive 108 as described above and the liner 108 contacts the other side of the adhesive as also described above.

The labels 110 that are described herein may be applied to a package by attaching the label to the body of the package. For example, the label may be applied to a box, plastic wrap, Styrofoam™, deli wrapping paper, etc. More particularly, to apply the label to the package body, the liner 108 is removed from the label 110 to expose the adhesive and the label 110 is applied to the package body using the adhesive. In using the label in this way, a package having a label of the type described herein is provided. For example, the label includes a top layer having a front side and a back side and a repositionable adhesive covering the entirety of the back side of the top layer. The label is applied to the package body such that the package body directly contacts the repositionable adhesive to sandwich the repositionable adhesive between the top layer and the package body.

The label assemblies described herein may be manufactured using a variety of processes. In an embodiment, a repositionable adhesive of the type describe above is applied to the entirety of the back side of the top layer of the label assembly. For example, in at least some embodiments, the adhesive may be coated onto the back side of the top layer. The adhesive is then covered with the silicone-free liner by applying the liner directly to the repositionable adhesive to sandwich the repositionable adhesive between the top layer and the liner.

Once the liner has been applied to the adhesive, the label assembly may be further processed by cutting the top layer into a plurality of regions, each associated with a separate label. The cutting may include die cutting or butt cutting or sheeting. Sheeting produces rectangular labels with square corners that are sheeted individually.

Furthermore, in at least some embodiments, the liner may be perforated to create a plurality of regions, each associated with a separate label.

While the embodiments described herein have generally described paper-based top layers 102 and liners 108, in other embodiments, one or both of the top layer 102 or the liner 108 may be polyethylene terephthalate (PET) based or may be constructed of other films and coated papers of various thicknesses. For example, in some embodiments, the top layer 102 may be PET-based to allow for improved performance in wet environments (e.g., where the label is to be applied to a bottle).

Certain adaptations and modifications of the described embodiments can be made. Therefore, the above discussed embodiments are considered to be illustrative and not restrictive.

What is claimed is:

1. A label assembly comprising:
a top layer having a front side and a back side;
a repositionable adhesive covering the entirety of the back side of the top layer; and
a silicone-free liner contacting the repositionable adhesive to sandwich the repositionable adhesive between the top layer and the liner.

2. The label assembly of claim 1, wherein the silicone-free liner contains no silicone.

3. The label assembly of claim 1, wherein the silicone-free liner is uncoated.

4. The label assembly of claim 1, wherein the silicone-free liner has an external side opposite the side of the silicone-free liner that contacts the repositionable adhesive and wherein the external side does not contact any adhesive.

5. The label assembly of claim 4, wherein the label assembly is provided on a roll and wherein the external side contacts a top layer of another portion of the roll.

6. The label assembly of claim 1, wherein the liner is paper-based.

7. The label assembly of claim 6, wherein the top layer is paper-based.

8. The label assembly of claim 6 wherein the liner is constructed of a paper having a paper density greater than or equal to fifty grams per square meter.

9. The label assembly of claim 8, wherein the paper has a paper density of between fifty and one hundred and fifty grams per square meter.

10. The label assembly of claim 6, wherein the liner is constructed of unbleached kraft paper or copy paper.

11. The label assembly of claim 1, wherein the top layer is a label sheet having a plurality of label regions, each associated with a separate label, and wherein the repositionable adhesive contacts the entire back side of the plurality of label regions.

12. The label assembly of claim 11, wherein the labels are die cut.

13. The label assembly of claim 11, wherein the labels are butt cut.

14. The label assembly of claim 1, wherein the top layer is a label.

15. The label assembly of claim 1, wherein the liner is a single layer liner.

16. The label assembly of claim 1, further comprising:
indicia printed on the front side of the top layer.

17. The label assembly of claim 1, wherein the repositionable adhesive is a microsphere adhesive.

18. The label assembly of claim 1, wherein the top layer is a label sheet having a plurality of label regions, each associated with a separate label, and wherein the liner is perforated at regions which demarcate the labels.

19. A package having a label, comprising:
a label having a top layer having a front side and a back side and a repositionable adhesive covering the entirety of the back side of the top layer; and
a package body directly contacting the repositionable adhesive to sandwich the repositionable adhesive between the top layer and the package body.

20. A method of preparing a label assembly, the method comprising:
applying a repositionable adhesive to an entirety of a back side of a top layer of the label assembly; and
covering the repositionable adhesive with a silicone-free liner by applying the liner directly to the repositionable adhesive to sandwich the repositionable adhesive between the top layer and the liner.
